(19) United States
(12) Patent Application Publication
(10) Pub. No.: US 2019/0152688 A1
(43) Pub. Date: May 23, 2019

(54) CONE CAKE HOLDERS

(71) Applicant: Kimberley Leilani LOWRY, Savannah, GA (US)

(72) Inventor: Kimberley Leilani LOWRY, Savannah, GA (US)

(21) Appl. No.: 16/190,725

(22) Filed: Nov. 14, 2018

Related U.S. Application Data
(60) Provisional application No. 62/587,891, filed on Nov. 17, 2017.

(51) Int. Cl. B65D 85/36; A47J 47/14; A47J 37/01; B65D 85/60

(52) U.S. Cl. CPC B65D 85/36; B65D 85/60; A47J 37/01; A47J 47/14

(57) ABSTRACT

A cone cake holder that includes a generally circular base with an upper portion and a lower portion, a planar top portion disposed on the upper portion and forming a cavity within the top portion and base, and a bore is positioned within the top portion and proceeding into the cavity.

### CROSS REFERENCE TO RELATED PATENT APPLICATION

The present patent application/patent claims the benefit of priority of co-pending U.S. Provisional Patent Application No. 62/587,891, filed on Nov. 17, 2017, and entitled “CONE CAKE HOLDERS,” the contents of which are incorporated in full by reference herein.

### FIELD OF THE INVENTION

The present invention relates generally to a cone cake holder for assisting in baking cone cakes and more generally relates to a cone cake holder for retaining a cone for baking and displaying cone cakes, which may be disposable.

### BACKGROUND OF THE INVENTION

Cone cakes are cupcakes baked inside flat-bottom ice cream cones. The batter is inserted within the ice cream cone and baked. As the cone cake is baked, the batter rises and changing the center of gravity of the cone cake, resulting in the cone cake falling during the baking process. Transporting the cone cake is also problematic, because they can fall over easy, thus ruining any design that may be incorporated on the cone cake.

It is an object of the present invention to provide an individual device, that can be disposable, for assisting in the baking, transportation, and display of cone cakes.

### BRIEF SUMMARY OF THE INVENTION

According to an embodiment of the present invention, a cone cake holder includes a generally circular base with an upper portion and a lower portion, a top portion disposed on the upper portion and forming a cavity within the top portion and base, and a bore is positioned within the top portion and proceeding into the cavity.

According to another embodiment of the present invention, a cone cake holder includes a stabilizing portion that extends from the lower portion to an upper portion of the base.

According to yet another embodiment of the present invention, a cone cake holder is composed of bake safe paper.

According to yet another embodiment of the present invention, a cone cake holder is composed of silicone.

According to yet another embodiment of the present invention, a cone cake holder is composed of metal.

According to yet another embodiment of the present invention, a cone cake holder includes a pair of opposed sides that each extend to an upper edge, a planar top portion disposed on the upper portion and forming a cavity, and a bore positioned within the top portion.

According to yet another embodiment of the present invention, a cone cake holder includes a cavity formed within the pairs of opposed sides and planar top portion.

According to yet another embodiment of the present invention, a cone cake holder includes a bore extending from the planar top portion and into the cavity.

### BRIEF DESCRIPTION OF THE DRAWINGS

The present invention is illustrated and described herein with reference to the various drawings, in which like reference numbers denote like method steps and/or system components, respectively, and in which:

FIG. 1 is a side-perspective view of the cone cake holder of the present invention;

FIG. 2 is a top view of the cone cake holder of the present invention;

FIG. 3 is a bottom view of the cone cake holder of the present invention;

FIG. 4 is a side-perspective view of the cone cake holder of the present invention in use;

FIG. 5 is a perspective view of another embodiment of the cone cake holder of the present invention in use;

FIG. 6A is a perspective view of a cone cake; and

FIG. 6B is a cone cake split in half illustrating the inside of the cone cake.

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

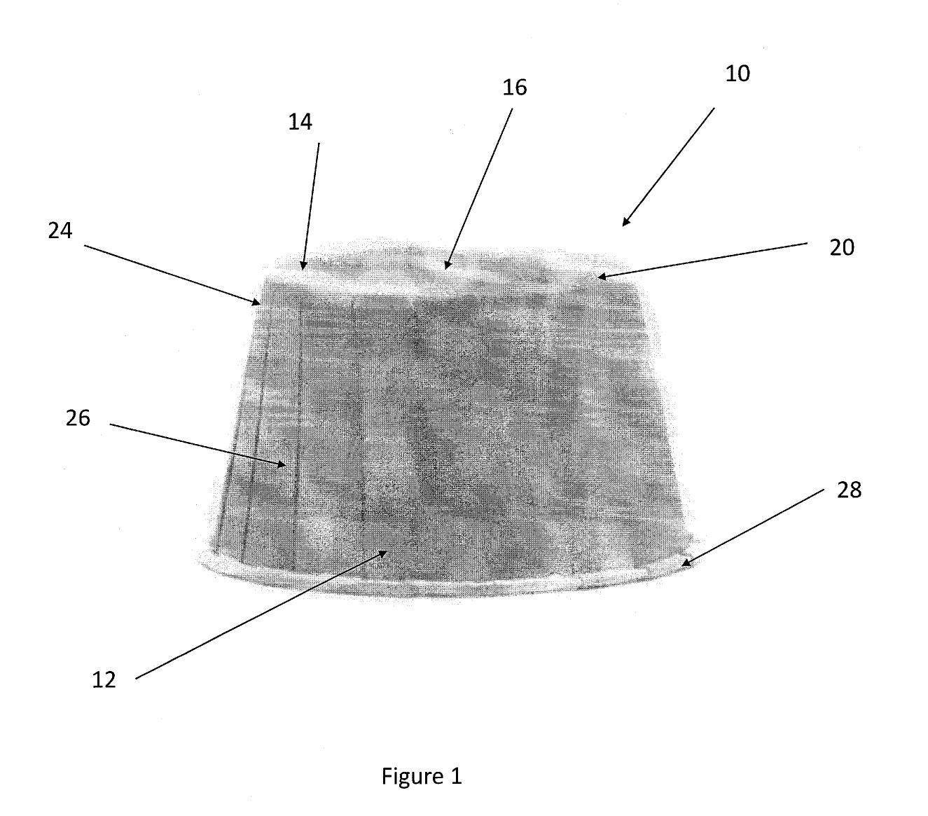

Referring now specifically to the drawings, a cone cake holder is illustrated in FIG. 1 and is shown generally at reference numeral 10. The cone cake holder 10 is designed to retain and stabilize an ice cream cone during the preparation and baking of cone cakes. The cone cake holder 10 contains a generally circular base portion 12 with a lower portion and an upper portion. The circular base portion 12 has a height and extends from the lower portion to an upper portion.

The upper portion contains a generally circular top portion 14. A bore 16 is disposed within the top portion 14 of the base 12. The bore 16 extends from the outer surface to the inner surface of the top portion 14. The bore 16 provides access to an interior cavity 18 of the cone cake holder 10. Preferably, the bore 16 is generally circular in shape and has a diameter slightly larger than the diameter of an ice cream cone. The bore 16 is surrounded by a concentric shelf 20 disposed within the top portion 14. The concentric shelf 20 extends over the cavity 18 and is generally flat and planar to the surface the cone cake holder 10 is placed.

As illustrated in FIG. 1, the base 12 contains a concentric side portion 24 that may contain at least one stabilizing portion 26 disposed on the external side of the side portion that extends from the lower portion to the upper portion of the base 12. The stabilizing portion 26, as shown in FIG. 1, is composed of a plurality of reinforced folds in a spaced-apart arrangement, wherein the side portion 24 of the base 12 is folded onto itself. In other words, the side portion 24 is doubled-up, creating a portion of the side portion 24 that is two layers, creating the stabilizing portion 26. The stabilizing portion 26 provides extra support for the device 10. Preferably, the stabilizing portion 26 is equally spaced apart along the external side of the side portion 24. The stabilizing portion 26 is a double layer separated by a single layer of the side portion 24. The stabilizing portion 26 alternates with the single layer of the side portion 24 along the external side of the side portion 24. Alternatively, other elements that may stabilize the device 10 may also be used.

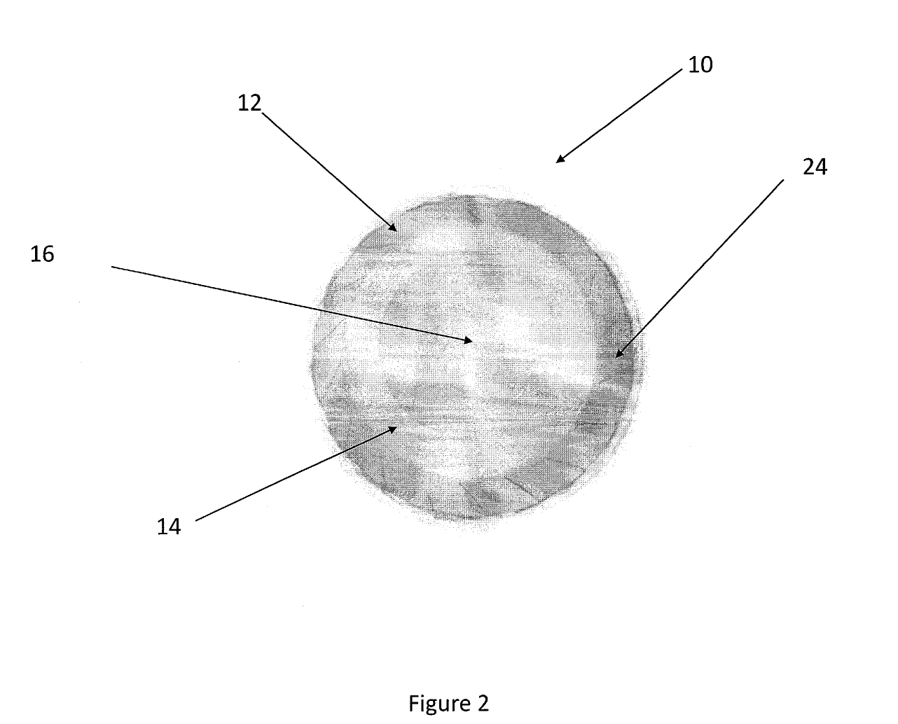

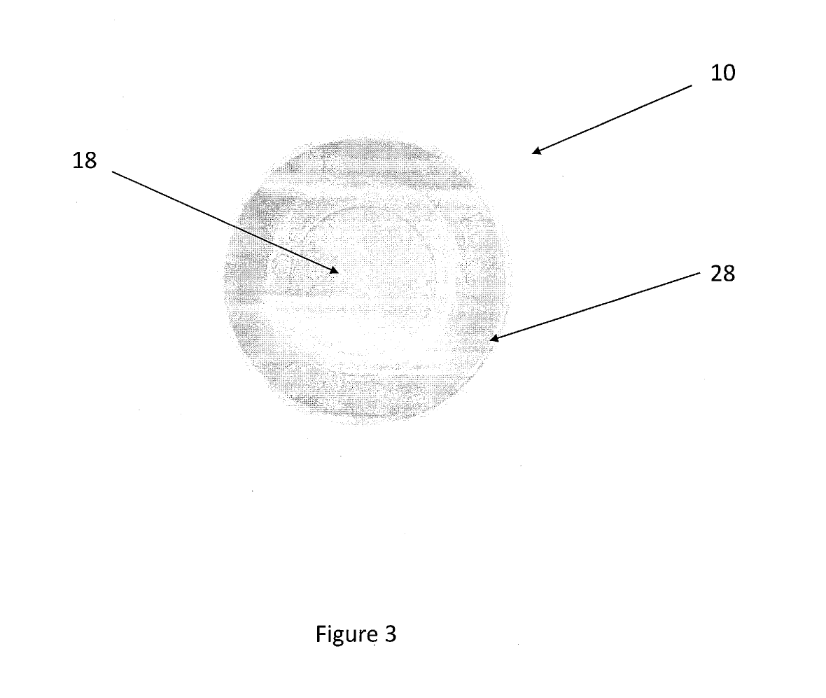

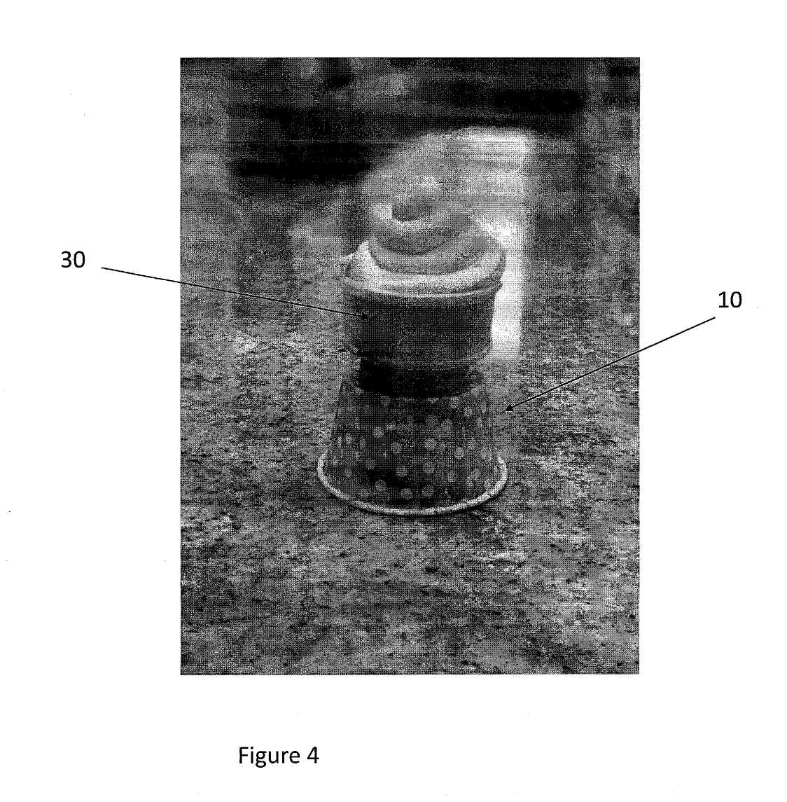

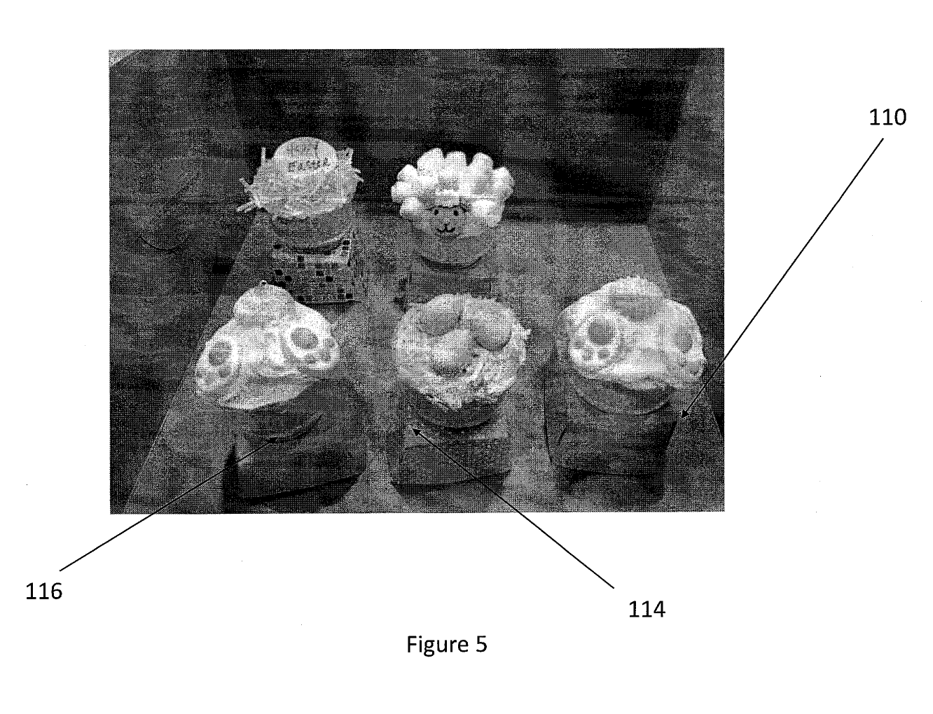

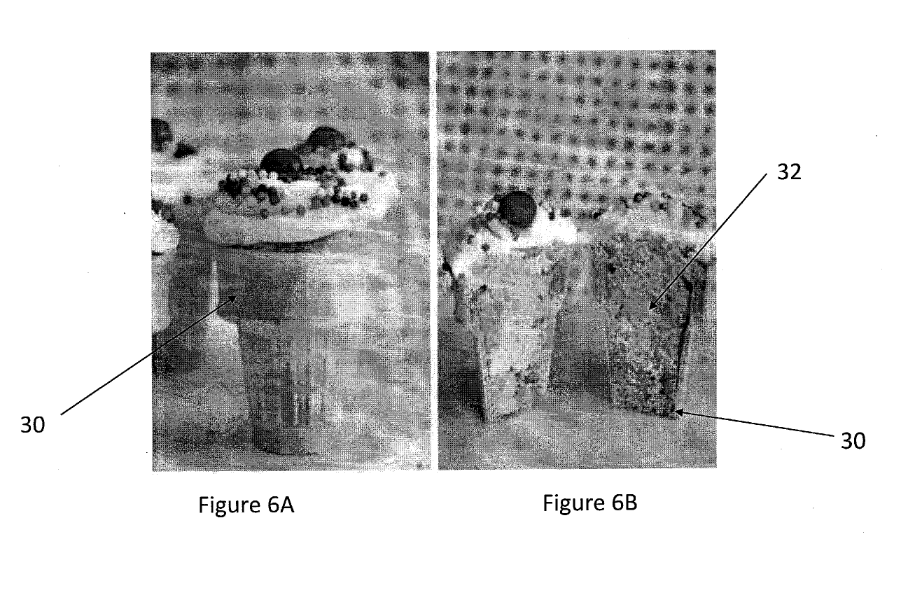

The stabilizing portion 26 extends from the top portion to the lower portion of the circular base portion 20. As shown in FIGS. 1 and 2, the stabilizing portion 26 may be angled from the upper portion to the lower portion of the circular base portion 20. In other words, the stabilizing portion 26 extends at an angle downward from the upper portion to the lower portion of the circular base portion 20. The lower portion contains a lip 28 that extends outward from the side portion 24 and surrounds the lower portion of the circular base portion 20. The lip 28 provides a base for the lower portion to engage the surface the cone cake holder 10 is placed upon. The lip 28 may also be formed from turning an end of the side portion 24 at the lower portion of the cone cake holder 10 upwards and rolling backwards, such that the end of the side portion engages an area of the side portion 24.

The diameter of the cone cake holder 10 increases from the upper portion to the lower portion. In other words, the upper portion of the cone cake holder 10 has a smaller diameter than the lower portion of the cone cake holder 10. The increase in diameter is gradual along the length of the cone cake holder 10.

Preferably, the cone cake holder 10 is made of bake safe paper such that it is disposable. However, the cone cake holder may be composed of other materials, such as metal, silicone, and the like.

During use, a cone 30 filed with batter 32 is placed within the bore 16. In this arrangement, the bottom side of the cone 30 extends within the cavity 18 of the cone cake holder 10. The bottom end of the cone 30 may actually contact the surface upon which the cone cake holder 10 is placed. A side portion of the shelf 20 contacts the side portion of the cone 30, keeping the cone 30 in an upright position.

In another alternative embodiment, the device 110 may have two opposed sides that each extend to an upper edge from a lower edge. A top portion 114 is disposed on the upper portion, forming a cavity within the top portion 114 and two opposed sides. A bore 116 is positioned within the top portion 114 and proceeds into the cavity. Preferably, the bore 116 is generally circular in shape and has a diameter slightly larger than the diameter of the base portion of an ice cream cone.

Alternatively, the device 110 may be a form having a planar portion 114 with four edges that will be the planar top portion 114. Four side portions extend outwardly from the four edges. The side portions may be bent at a 90° angle at the edges forming sidewalls. The side portions contain a first side and a second side. The first side contains a tab and the second side contains a slot. The tab of each sidewall is inserted into the slot of the adjacent sidewall, resulting in each sidewall engaged to the adjacent sidewall. A cavity is formed within the top portion 114 and the four sides. A bore is formed within the top portion and extends within the cavity.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A cone cake holder comprising:
a generally circular base with an upper portion, a lower portion, and a side portion;
a top portion disposed on the upper portion;
a cavity; and
a bore positioned within the top portion.

2. The cone cake holder according to claim 1, further comprising a stabilizing portion on the side portion that extends from the lower portion to an upper portion of the base.

3. The cone cake holder according to claim 1, wherein the cone cake holder is composed of bake safe paper.

4. The cone cake holder according to claim 1, wherein the cone cake holder is composed of silicone.

5. The cone cake holder according to claim 1, wherein the cone cake holder is composed of metal.

6. A cone cake holder comprising:
a generally circular base with an upper portion, a lower portion, and a side portion;
a top portion disposed on the upper portion;
a cavity;
a bore positioned within the top portion; and
a shelf surrounding the bore and extending over the cavity.

7. The cone cake holder according to claim 6, further comprising a stabilizing portion on the side portion that extends from the lower portion to an upper portion of the base.

8. The cone cake holder according to claim 6, wherein the cone cake holder is composed of bake safe paper.

9. The cone cake holder according to claim 6, wherein the cone cake holder is composed of silicone.

10. The cone cake holder according to claim 6, wherein the diameter of the upper portion of the base is smaller than the diameter of the lower portion of the base.

11. A cone cake holder comprising:
a generally circular base with an upper portion, a lower portion, and a side portion, wherein the upper portion has a diameter smaller than the diameter of the lower portion;
a top portion disposed on the upper portion of the base;
a cavity formed within the base;
a bore positioned within the top portion; and
a shelf surrounding the bore and extending over the cavity.

12. The cone cake holder according to claim 11, further comprising a stabilizing portion on the side portion that extends from the lower portion to an upper portion of the base.

13. The cone cake holder according to claim 11, wherein the cone cake holder is composed of bake safe paper.

14. The cone cake holder according to claim 11, wherein the cone cake holder is composed of silicone.

15. The cone cake holder according to claim 11, wherein the cone cake holder is composed of metal.
